(19) United States
(12) Patent Application Publication
(10) Pub. No.: US 2026/0341109 A1
(43) Pub. Date: Oct. 29, 2026

(54) Game Copying Prevention Security Architecture

(71) Applicant: Aristocrat Technologies, Inc., Las Vegas, NV (US)

(72) Inventors: Nimish Purohit, Las Vegas, NV (US); Oleksandr Siryi, Wroclaw (PL); Tyson Adams, Henderson, NV (US); Roman Seifert, Sydney (AU); Anthony Maffucci, Las Vegas, NV (US)

(21) Appl. No.: 19/345,587

(22) Filed: Sep. 30, 2025

Related U.S. Application Data
(60) Provisional application No. 63/796,081, filed on Apr. 28, 2025.

(51) Int. Cl. G07F 17/32; G06F 7/58; G06F 21/60

(52) U.S. Cl. CPC G07F 17/3241; G06F 7/588; G06F 21/602; G07F 17/3213

(57) ABSTRACT

Systems and techniques are disclosed for securing electronic gaming machine (EGM) data (e.g., game media) and preventing the copying and/or reselling thereof by unauthorized parties. Some embodiments are built on the implementation of a multi-layered wrapped key verification system, enabling the securing of uniform game software across a set of one or multiple EGMs. Other techniques disclosed include: the use of secured environments, such as Trusted Platform Modules (TPMs), with hardware-implemented logic; the use of TPMs with measured boot operations; the use of Time Lock Puzzles to protect game math; the use of TPMs with locked licensing schemes requiring license reactivation if an EGM changes markets; and proprietary inter-cabinet communication techniques to relay license information to a set of related EGMs. Other embodiments include a novel security architecture that adds an additional delayed linking process between a smart card and game media with an EGM after installation in the field.

### TECHNICAL FIELD

This disclosure relates generally to secure environments, and, more particularly, to systems and techniques for securing electronic machine data (e.g., game media) and preventing the copying thereof by unauthorized parties.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

However, today's electronic gaming machines do not have adequate security mechanisms to ensure games have not been counterfeited, copied, and/or resold without authorization. In other words, games can be cloned (and/or parts of EGMs, such as carrier boards, memory cards, smart cards, etc., may simply be removed) and placed into unauthorized gaming machines without the consent of the gaming manufacturer. Gaming manufacturer game data may be stored on a memory device included with the game at point of purchase (e.g., a CompactFast (CFast) memory card, or similar memory card technologies). Should the game be physically intercepted—e.g., either on route to (or after) the install—the CFast memory card (or other memory device) can be stolen and have its data copied, so that the game would be able to run on unauthorized machines. Whether these machines utilize unauthorized hardware and/or firmware originally belonging to or licensed by the manufacturer, or imitation hardware and firmware, it may be possible for the game to be fully copied onto and run on such unauthorized machines.

While a secure environment, whether that be hardware or software, can be implemented to encrypt the gaming manufacturer's data, it may suffer from one of two main deficiencies. First, necessary third-party regulators cannot access the encrypted game data to ensure its integrity. Second, in the case regulators can access the data, the decryption key may be stolen by a nefarious party separately from the hashed game data, allowing the nefarious party to run the game on unauthorized machines without interference. In a case where the key is “wrapped” (i.e., encrypted using another key) utilizing a hardware secure environment, interceptors who gain access to the secure environment would still be able to run the game on unauthorized cabinets. In such a case, the game data—even if encrypted—could be copied multiple times and/or run on a theoretically unlimited number of unauthorized machines.

Thus, novel techniques are needed to improve the state-of-the-art technology with respect to securing electronic gaming machine data and preventing the copying thereof by unauthorized parties.

Additionally, copy protection mechanisms in today's electronic gaming machines are primarily reliant on “chain of custody” processes for shipments and returns, which may include various protection gaps. Such protection gaps provide bad actors with a chance to illegally obtain confidential and proprietary information—as well as a pathway to be able to reverse engineer a game supplier's gaming products. Currently, some EGMs may include “smart card” technology, i.e., a physical card or other form of security device that is cryptographically signed and linked to game software to protect illegal production of game software. Thus, if a bad actor copies the game software stored in the EGM (e.g., in the form of a memory card, or the like), the copies will not run or execute on another device because: (1) there would not be a smart card linked to those unauthorized game software copies; and/or (2) there would be a mismatch between the smart card and copied game software.

Current solutions, however, do not prevent an individual/entity from reselling a legitimate copy of the game software and/or moving the game software onto unapproved EGM cabinets. As an example, when a game supplier deactivates the game product for the original customer, the original customer can subsequently resell the game product to an unauthorized third party by providing both the game software and smart card together.

Thus, because such current solutions cannot technologically prohibit the game product from reactivating at an unauthorized customer's location, there is also need for a novel security architecture that prevents third parties from selling or moving game software to unauthorized entities and/or into unapproved EGM hardware.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment, according to one example.

FIG. 2C is a diagram that shows examples of components of a system for providing online gaming, according to some aspects of the present disclosure.

FIG. 3 illustrates, a network architecture for an example system for facilitating license verification, in accordance with one or more embodiments.

FIG. 4 is a diagram of a technique for performing a hardware-to-software coupling security scheme, in accordance with one or more embodiments.

FIG. 5 is a diagram of a technique for performing a hardware-to-software coupling security scheme involving wrapped encryption keys, in accordance with one or more embodiments.

FIG. 6A shows a flowchart of a technique for performing a hardware-to-software coupling security scheme, according to some embodiments.

FIG. 6B shows a flowchart of a technique for performing a software verification operation by a third-party regulator, according to some embodiments.

FIG. 7 is a diagram of a technique for utilizing a secured environment, such as a Trusted Platform Module (TPM), with hardware-implemented logic, according to some embodiments.

FIG. 8 shows a flowchart of a technique for utilizing a secured environment, such as a TPM, with hardware-implemented logic, according to some embodiments.

FIG. 9 is a diagram of a technique for utilizing a secured environment, such as a TPM, with a measured boot operation, according to some embodiments.

FIG. 10 shows a flowchart of a technique for utilizing a secured environment, such as a TPM, with a measured boot operation, according to some embodiments.

FIG. 11 is a diagram of a technique for utilizing time lock puzzles in electronic gaming machines, according to some embodiments.

FIG. 12 shows a flowchart of a technique for utilizing time lock puzzles in electronic gaming machines, according to some embodiments.

FIG. 13 is a diagram of a technique for utilizing a secured environment, such as a TPM, to lock game licensing activation to a particular market, according to some embodiments.

FIG. 14 shows a flowchart of a technique for utilizing a secured environment, such as a TPM, to lock game licensing activation to a particular market, according to some embodiments.

FIG. 15 is a diagram of a technique for utilizing inter-cabinet communications between electronic gaming machines for licensing-related operations, according to some embodiments.

FIG. 16 shows a flowchart of a technique for utilizing inter-cabinet communications between electronic gaming machines for licensing-related operations, according to some embodiments.

FIG. 17 is a diagram of a technique for linking game software storage media and a smart card at production, and then subsequently linking the smart card and EGM hardware components in the field after a certain amount of play and/or time elapses, according to some embodiments.

FIG. 18 shows a flowchart of a technique linking game software storage media and a smart card at production, and then subsequently linking the smart card and EGM hardware components in the field after a certain amount of play and/or time elapses, according to some embodiments.

### DETAILED DESCRIPTION

Embodiments described herein are directed to various systems and techniques for securing electronic data (e.g., electronic gaming machine data) and preventing the copying thereof by unauthorized parties. The techniques described herein provide several technical improvements in the fields of cryptography, data validation, and hardware/firmware protection.

More specifically, some embodiments described herein are built on the implementation of a multi-layered wrapped key verification system, also referred to herein as “hardware-to-software coupling,” enabling the securing of uniform game software across a set of one or multiple electronic gaming devices. For example, according to some such implementations, a thrice-wrapped game encryption key is used to unlock game data on an individual machine and ensure the security of the game data against unauthorized access, while enabling the ability of third-party regulators to confirm the veracity of the game data across all devices within a predetermined set of machines—without gaining physical access to the unencrypted game data. Such wrapped key implementations help to better ensure the security of the game data against unlawful and/or incorrect iterations of games being procured, as well as preventing the unauthorized harvesting of game data.

According to some implementations, a deterministic encryption process may be used to protect the game data. For example, methods may include generating the game keys non-deterministically, wherein the game keys are unique to a particular gaming machine(s). To couple the gaming hardware to individual pieces of software, the game software itself may be encrypted deterministically. This also allows third party regulators to independently prove and verify the game data—without actually accessing the underlying software code.

According to some embodiments, a computer-implemented method of hardware-to-software coupling is disclosed, comprising: obtaining an executable game file (e.g., a binary file); creating a first decryption key, (K1), for the executable game file; encrypting the executable game file with the first decryption key, (K1); encrypting the first decryption key, (K1), with a first wrap key, (K2), resulting in a first encrypted key, K2(K1); encrypting the first encrypted key, K2(K1), with a first coupling key, (Coupling_Key), resulting in a second encrypted key, Coupling_Key(K2(K1)); and encrypting the second encrypted key, Coupling_Key(K2(K1)), with a first per-machine key, (KBn), resulting in a third encrypted key, KBn(Coupling_Key(K2(K1))), wherein the first per-machine key, (KBn), is a private key associated with a particular machine, and wherein the first coupling key, (Coupling_Key), is associated with a particular media instance containing the executable game file.

According to some such embodiments, encrypting the executable game file with the first decryption key, (K1), comprises performing a deterministic encryption process, e.g., wherein a result of encrypting the executable game file with the first decryption key, (K1), is the same across all machines having a same version of the executable game file.

According to other such embodiments, the first per-machine key, (KBn), is stored in a secured environment, such as a Trusted Platform Module (TPM), of the particular machine.

According to other such embodiments, the method further comprises: receiving, from a third-party, an initiation of a verification request for the executable game file; and providing, to the third party, the first coupling key, (Coupling_Key), and a public key corresponding to the first per-machine key, (KPn), e.g., wherein encrypting the first coupling key, (Coupling_Key), with (KPn) results in an identical value to the third encrypted key. According to some such embodiments, the first coupling key, (Coupling_Key), is configured to be used by the third party to decrypt only an outermost layer of first encrypted key, K2(K1), wherein the first wrap key, (K2), is not provided to the third party. According to other such embodiments, the first encrypted key, K2(K1), is configured for the third party to use a Hash-based Message Authentication Code (HMAC) key to certify the contents of the executable game file, and wherein the executable game file remains encrypted to the third party.

According to other such embodiments, the first wrap key, (K2), is shared across all machines executing a same version of the executable game file in a given jurisdiction.

According to other implementations, hardware-implemented logic may be used in conjunction with hardware-to-software coupling techniques to provide additional security features. For example, a computer-implemented method of leveraging hardware-implemented logic with hardware-to-software coupling is disclosed, comprising: obtaining, at a game machine, an executable game file, wherein the executable game file comprises an encrypted bitstream; authenticating the executable game file; decrypting, using a configurable hardware circuit at the game machine, the encrypted bitstream; and executing, by a processor of the game machine, the executable game file, wherein communications between the processor and the configurable hardware circuit during the execution are encrypted.

According to some such embodiments, the executing is performed, at least in part, by a secured environment, such as a Trusted Platform Module (TPM), of the game machine, and/or the configurable hardware circuit comprises a Field-Programmable Gate Array (FPGA).

According to some such embodiments, the method further comprises: certifying a hash of the encrypted bitstream, wherein the certified hash is configured for use in verifying content of the FPGA.

According to other such embodiments, the encrypted bitstream comprises a portion of business logic for the executable game file.

According to still other implementations, a secured environment, such as a Trusted Platform Module (TPM), with a measured boot operation may be utilized to detect tampering or unauthorized changes with an electronic gaming machine. For example, a computer-implemented method of leveraging a TPM with a measured boot operation is disclosed, comprising: initiating, at a game machine, a system boot operation, wherein the game machine comprises a secured environment; measuring one or more system components; extending the one or more measurements into platform configuration registers (PCRs) of the secured environment; determining, based on the one or more measurements, whether the system is in a known and uncompromised state; and performing, in response to determining that the system is in a known and uncompromised state, one or more cryptographic operations related to game data stored on the game machine.

According to some such embodiments, the method further comprises, in response to determining that the system is not in a known and uncompromised state: sealing one or more cryptographic keys to the game machine; and refusing to decrypt, using the secured environment, the game data stored on the game machine.

According to yet other implementations, systems can be designed using a Time-Lock puzzle encryption system, e.g., based on game math data. For example, a computer-implemented method of using Time-Lock puzzles is disclosed, comprising: obtaining an executable game file on a game machine, wherein the executable game file may comprise one or more Probability Accounting Report (PAR) sheets, wherein each PAR sheet comprises one or more probability values, and wherein the one or more probability values for each PAR sheet are encrypted; executing a round of gameplay in the executable game; generating at least one random number, based on output from a random number generator (RNG); performing a lookup operation based on the at least one random number to locate an encrypted puzzle stored in a memory of the gaming machine, wherein the encrypted puzzle is part of a set of time-lock puzzles used to encrypt at least one lookup table for determining random game outcomes; decrypting the located encrypted puzzle stored in the memory of the gaming machine without decrypting other encrypted puzzles in the set of time-lock puzzles; solving the decrypted puzzle; determining a result for the round of gameplay based on the solved puzzle; and displaying the result for the round of gameplay on a display of the game machine.

According to some such embodiments, one or more animations are initiated on the display of the game machine during the decrypting and solving of the puzzle.

According to some such embodiments, the result for the round of gameplay is not known when the one or more animations are initiated.

According to some such embodiments, solving the decrypted puzzle is configured to take longer than a predetermined minimum solve time duration and/or less than a duration of one or more animations associated with the round of gameplay.

According to still other implementations, systems may utilize a secured environment, e.g., a TPM, to lock game licensing activation to a particular market. For example, a computer-implemented method of locking game licensing activation is disclosed, comprising: activating a game machine at a first location; measuring one or more first values from sensors of the game machine at the first location; storing the measured one or more first values into platform configuration registers (PCRs) of the secured environment of the game machine; cryptographically sealing activation information for the game machine into the secured environment based, at least in part, on the one or more first values; determining that the game machine has been moved to a second location, wherein the second location is different than the first location; measuring one or more second values from sensors of the game machine at the second location; determining, based on the one or more second values, that the secured environment is unable to unseal the activation information for the game machine; and requiring reactivation before the game machine may be used at the second location.

According to some such embodiments, the measured one or more first values comprise at least one of: a Global Positioning System (GPS) signal value; a cellular signal value; or a magnetometer signal value.

According to some such embodiments, the method further comprises: filtering at least one of the one or more first values prior to storage into the PCRs of the secured environment.

According to yet other implementations, systems may utilize inter-cabinet communications (i.e., between electronic gaming machines) for more efficiently performing licensing-related operations. For example, a computer-implemented method of utilizing inter-cabinet communications is disclosed, comprising: activating a first game machine, of a group of game machines, at a first location, wherein each game machine in the group comprises a radio module configured to communicate with the other game machines in the group; obtaining, at the first game machine, updated activation information; transmitting, using a radio module of the first game machine, the updated activation to one or more other game machines in the group; and reactivating the first game machine for operation based, at least in part, on the updated activation information.

According to still other implementations, methods of unauthorized resale prevention are disclosed that may comprise: obtaining an executable game file; obtaining a smart card, wherein the smart card and executable game file are linked; installing, at an electronic gaming machine (EGM), the smart card and the executable game file; confirming that usage criteria are met for the executable game file at the EGM; and in response to confirming that usage criteria are met, linking the smart card and executable game file with the EGM.

According to some such embodiments, the executable game file comprises a unique software ID.

According to other such embodiments, the smart card is cryptographically signed with a private key of a vendor of the executable game file.

According to other such embodiments, the smart card and executable game file are linked in a production environment, and the smart card and executable game file are linked with the EGM in a field environment.

According to other such embodiments, the usage criteria comprises one or more of: a criterion specifying a minimum required power-on duration for the EGM; and a criterion specifying a minimum required number of rounds of game play of the executable game on the EGM.

According to other such embodiments, linking the smart card and executable game file with the EGM further comprises: linking the smart card and the executable game file with two or more hardware identifiers associated with the EGM (e.g., a carrier board ID of a carrier board installed in the EGM and/or an EGM ID for the EGM.

According to other such embodiments, the smart card is configured to allow no more than a predefined number of rewrites of the two or more hardware identifiers.

According to other such embodiments, the executable game file is stored on a memory card.

As may be appreciated, any of the computed-implemented methods enumerated above may also be performed by an electronic gaming machine(s), comprising: memory; one or more processors; one or more displays; and instructions stored in the memory, wherein the instructions, when executed by the one or more processors, cause the game machine to perform any of the computed-implemented methods enumerated above. The computer-implemented methods enumerated above may also be embodied in one or more non-transitory computer-readable media, e.g., in the form of stored computer-executable instructions, which, when executed by one or more processors of an electronic device, such as an electronic gaming machine (EGM), cause the EGM to perform any of the computed-implemented methods enumerated above.

### Exemplary EGMs and Implementation Thereof

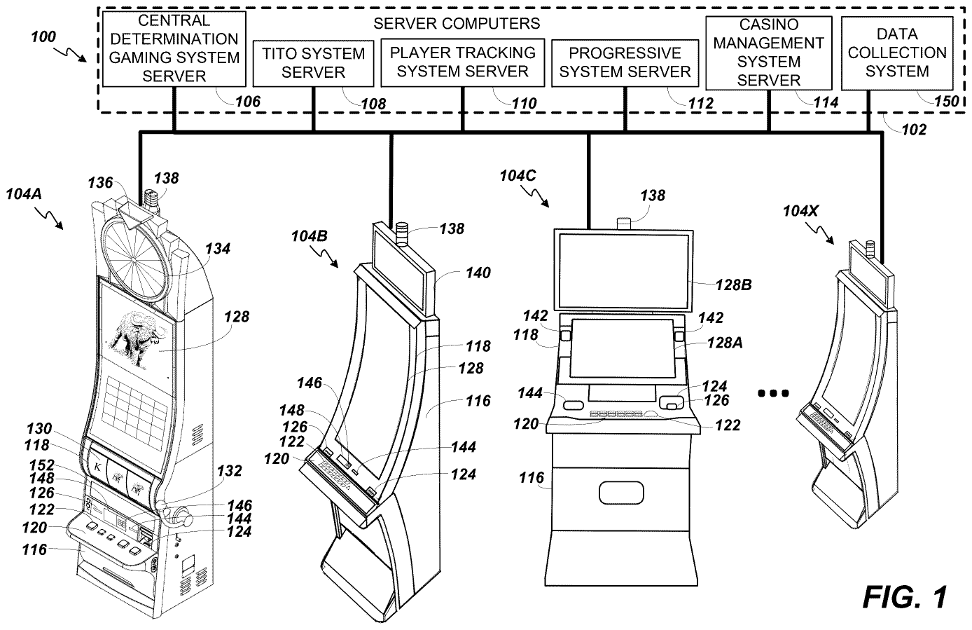

FIG. 1 illustrates several different models of EGMs, which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards. Additionally, or alternatively, one or more of gaming devices 104A-104X may be configured as a tabletop game.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (Wi-Fi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, a casino management system (CMS) server 114, and/or a data collection system 150 (e.g., to collect play-related and/or licensing-related data from the gaming devices at a given location, which data may later be used for data analytics, or the like). Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

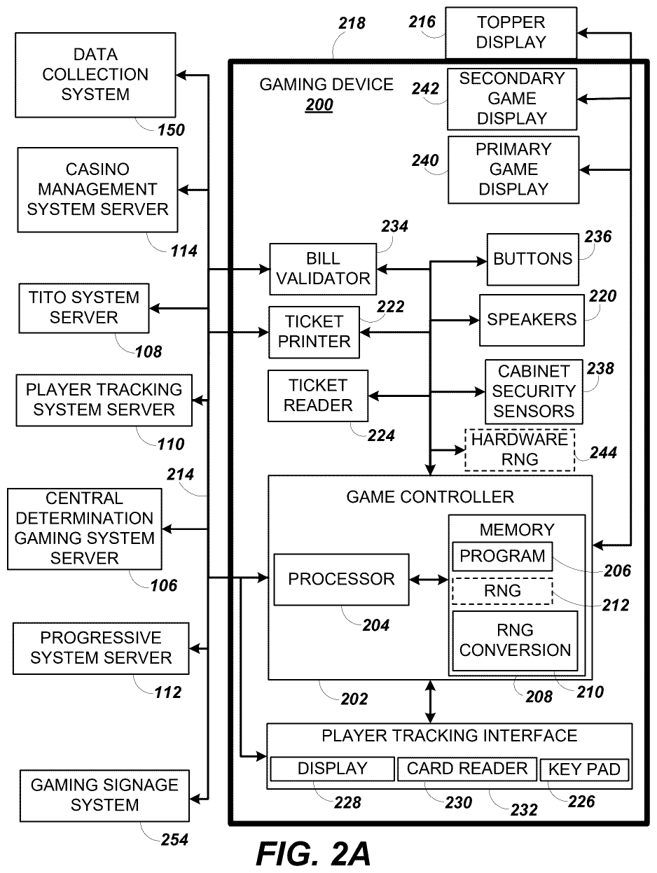

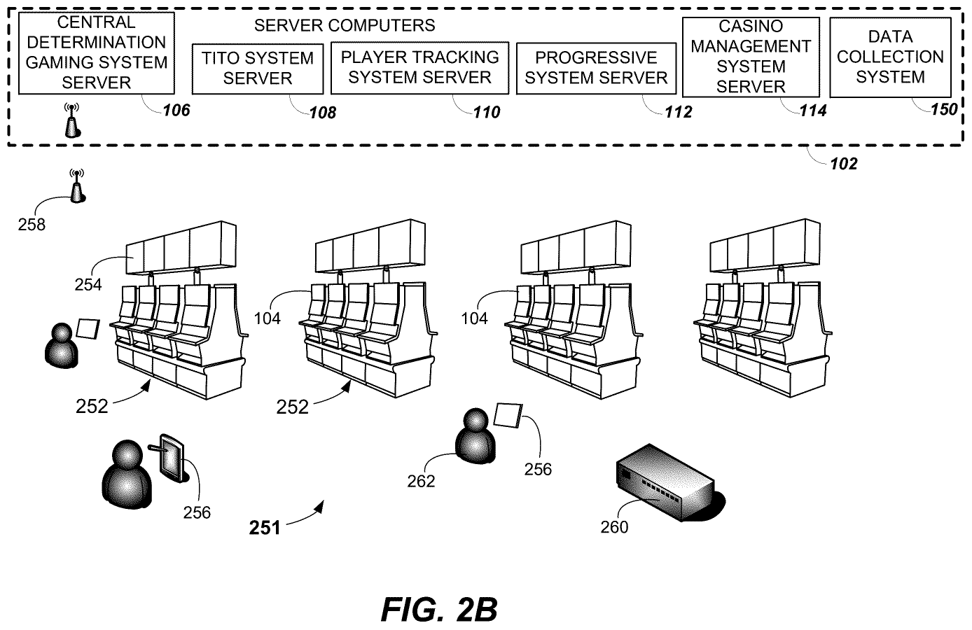

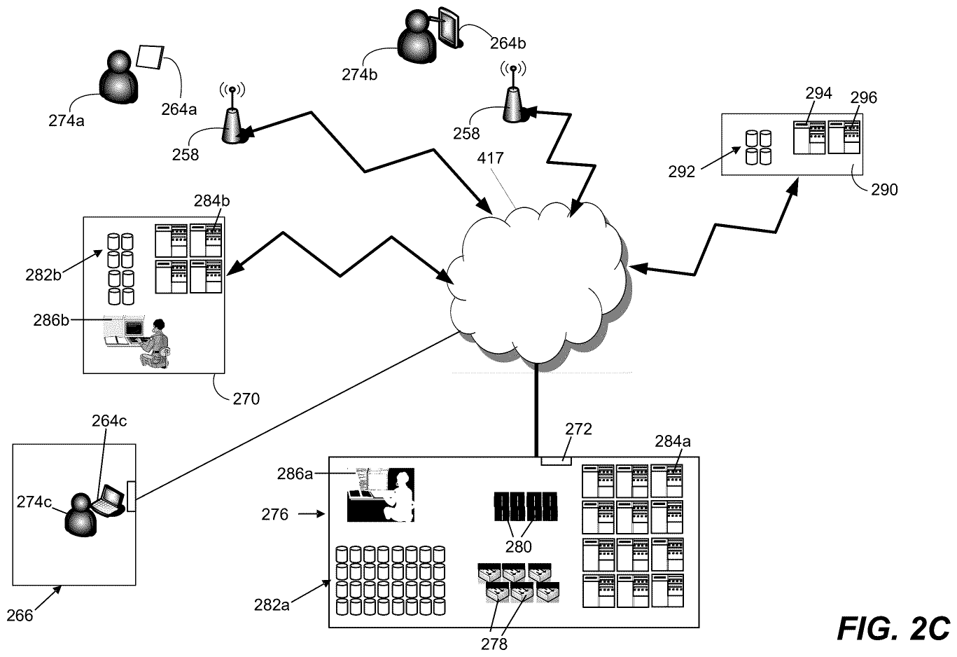

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Although gaming devices 104A-104X are shown in FIG. 1 as upright EGMs, the systems and methods described herein can be used on upright EGMs or table type EGMs.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

In an example embodiment, a tabletop EGM (not shown in FIG. 1) is provided which may be similar to the gaming devices 104. The tabletop EGM may include a horizontal display device that can be used by patrons as a conventional table surface as well as for providing player input (e.g., touchscreen surface, mechanical buttons, or the like) and display output (e.g., virtual wheel, virtual slot reels) for a tabletop game. The tabletop EGM may support participation for multiple players during game play (e.g., as patrons socially meet around the tabletop EGM). Example tabletop EGMs and features are described in greater detail below.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, computer code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In some embodiments, a data collection system 290 is also configured for communication via the networks 417. Here, the data collection system 290 includes a collection server 294 and an authentication server 296. According to some embodiments the collection server is configured to store the collected data for later use, such as data analytics and the like. In some embodiments, the collection server 294 may be configured to facilitate storage of collected data in an additional network storage 292. The data collection system 290 also includes an authentication server 296, which provides authentication services for devices collecting data. In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

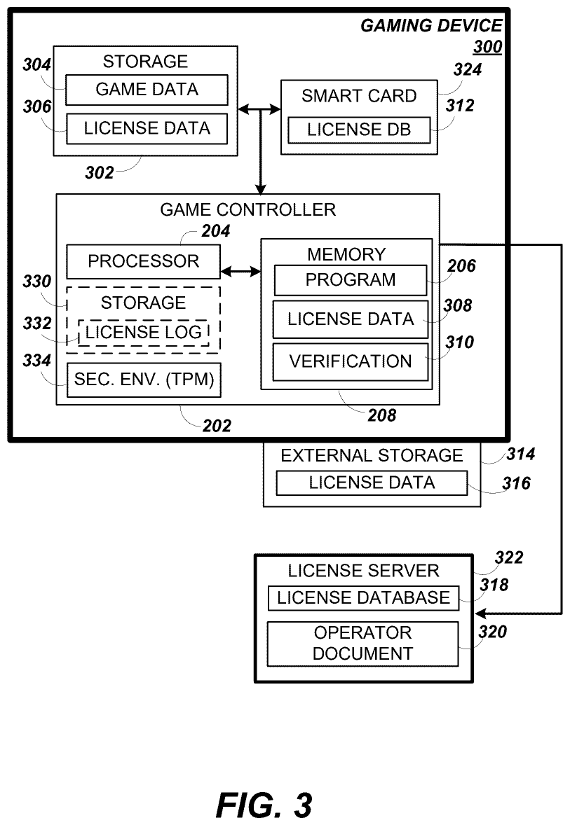

FIG. 3 is a block diagram of a gaming device 300, according to one or more embodiments. The gaming device 300 includes a game controller 202, configured to provide functionality for electronic games on the gaming device 300. The gaming device 300 may also include a smart card 324, which may be external to the game controller 202. The smart card 324 may be a device that stores data and can be read by a card reader. According to some embodiments, the smart card 324 is configured to store a license database 312. To that end, the smart card may act as a broker that contains legacy database history that, in some embodiments, cannot be erased or destroyed. The license database may include information such as a history information that indicates whether components of the game controller have previously run together. According to other embodiments, the smart card 324 is configured to store an encrypted version of game data for a particular game that is to be executed by the gaming device 300.

The game controller 202 may include various components, such as a processor 204, which is configured to execute computer readable code, such as computer programming modules in memory 208. The computer programing models in memory 208 may include a gaming program 206. In addition, memory 208 may also store a license data module 308 and a verification module 310. The license data module 308 may include a primary key and/or a derived key for a license. The verification module may be configured to perform a check on components within the gaming device to determine whether a game is licensed for the device. In some embodiments, the verification process can be performed when the gaming machine is initially deployed to a gaming site such as a casino. The verification process can also occur when a game controller memory 208 has been cleared, such as when a new game is added to the gaming device 300. In yet another example, the verification module can perform a license check when the gaming machine is powered off and on, moved to a different location, or on a periodic schedule.

In some embodiments, game controller 202 also includes an optional storage 330. Storage 330 may be a nonvolatile memory. Examples of storage 330 include read-only memory (ROM), hard disk drives, solid-state drives, universal serial bus (USB) flash drives, or the like. Examples of ROM include a programmable read-only memory (PROM), an erasable programmable read-only memory (EPROM), an electrically erasable programmable read-only memory (EEPROM), or other like memory device. According to one or more embodiments, the storage 330 in the game controller 202 may be configured to store license log 332. The license log 332 may be configured to store data related to the successful deployment of a new game. For example, the license log may capture license information, hardware information (such as hardware identifiers for the storage 302, smart card (e.g., CFast card) 324, or the like), time stamps or other contextual data indicative of circumstances around which the license was verified for initial (or subsequent) deployment of a game. In some embodiments, game controller 202 also includes an optional secured environment, e.g., a Trusted Platform Module (TPM) 334 (i.e., a specialized chip designed to enhance a device's security by securely storing cryptographic keys) or other hardware and/or software-implemented secured environments, such as hardware security modules (HSMs), trusted execution environments (TEEs), secure enclaves, etc.. Various roles and usages of secured environments, such as TPM 334, in providing greater cryptographic protection for gaming media are described below.

According to some embodiments, gaming device 300 also includes storage 302. Storage 302 may include a solid state drive (SSD) or other non-volatile storage device and may be external to the game controller 202. In some embodiments, storage 304 is configured to store game data 304, which may be used to execute the gaming program 206. Storage 302 may also be configured to store license data 306. License data 306 may include a primary key and/or a derived key for a license.

In some embodiments, gaming device 300 may be configured to read from external storage 314, such as through a USB connection or other means. External storage 314 may include license data 316. In some embodiments, an operator can use the external storage 314 to update license information on the components on gaming device 300.

Gaming device 300 may also communicate with a license server 322. License server 322 may include license information for the game, such as a license database 318, and an operator document 320. The gaming device 300 may connect to the license server, for example across a wide area network. License server 322 may provide up to date information about the license for the game.

### Trusted Platform Modules (TPMs) With Hardware-To-Software Coupling

Trusted Platform Modules (TPMs) are examples hardware-based secured environments, i.e., security devices designed to ensure the integrity and authenticity of a platform. Secured environments, e.g., TPMs, in combination with other techniques, force potential attackers to either invest significant resources into hacking the TPM or pay the time penalty and bottlenecking they introduce on algorithms that require time constraints and resist parallelization. For example, a typical TPM takes around 300 ms to decrypt a piece of ciphertext encrypted with 2048-bit RSA key, on top of having such a key relatively protected inside.

TPMs may be implemented in any of several different ways, such as: on a motherboard as a separate TPM chip (e.g., communicating with a CPU using a Serial Peripheral Interface (SPI)); as part of the CPU itself; or as a discrete add-on TPM module. Each implementation comes with its own advantages and disadvantages.

One important requirement from third-party regulators is the ability to be able to independently verify that the media under audit on electronic gaming machines corresponds exactly to previously certified firmware/software versions. Normal (i.e., non-deterministic) encryption works such that, every time a message is encrypted—even if it is the same message—it yields different results. This characteristic introduces obstacles for proper regulatory review, i.e., due to the lack of reproducibility of the output. However, the use of deterministic encryption schemes can resolve this concern, i.e., because with a given key, a deterministic encryption scheme produces the same binary result each time, thus granting third-party regulators the ability to reproduce the source code into a binary exactly.

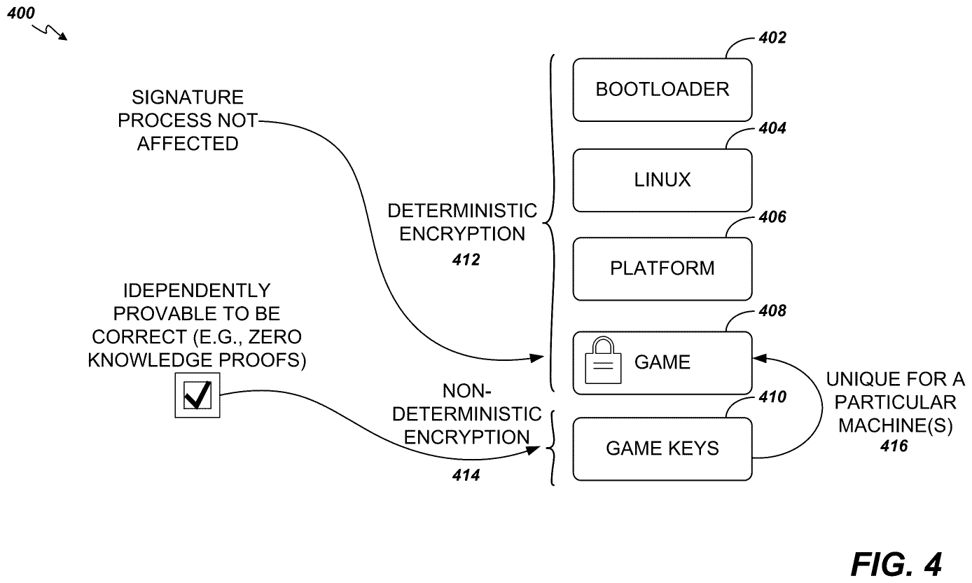

Turning now to FIG. 4, a diagram 400 of a technique for performing a hardware-to-software coupling security scheme is shown, in accordance with one or more embodiments. This embodiment approaches electronic game machines (also referred to herein as “cabinets”) individually. In other words, the media (e.g., electronic game software) is configured, such that it will only work with a specific game cabinet that it was “coupled” to. This is achieved by having the media encrypted in a specialized way—and with only one machine having the key necessary to decrypt it—while still reserving a way for third-party regulators to verify that media images are the same as previously certified firmware/software versions.

The electronic gaming machine firmware and software may comprise various representative components, e.g.: a bootloader 402; an operating system (e.g., Linux) 404; a gaming platform 406; and encrypted game media 408. As described above, according to some embodiments, components 402/404/406/408 may employ a deterministic encryption scheme 412, i.e., wherein, with a given key, the same binary result is produced each time the same file is encrypted. For example, game media 408 may be encrypted using AES-256 encryption or other suitable encryption algorithms. In this way, the signature process for the game media is not affected by the hardware-to-software coupling schemes described herein.

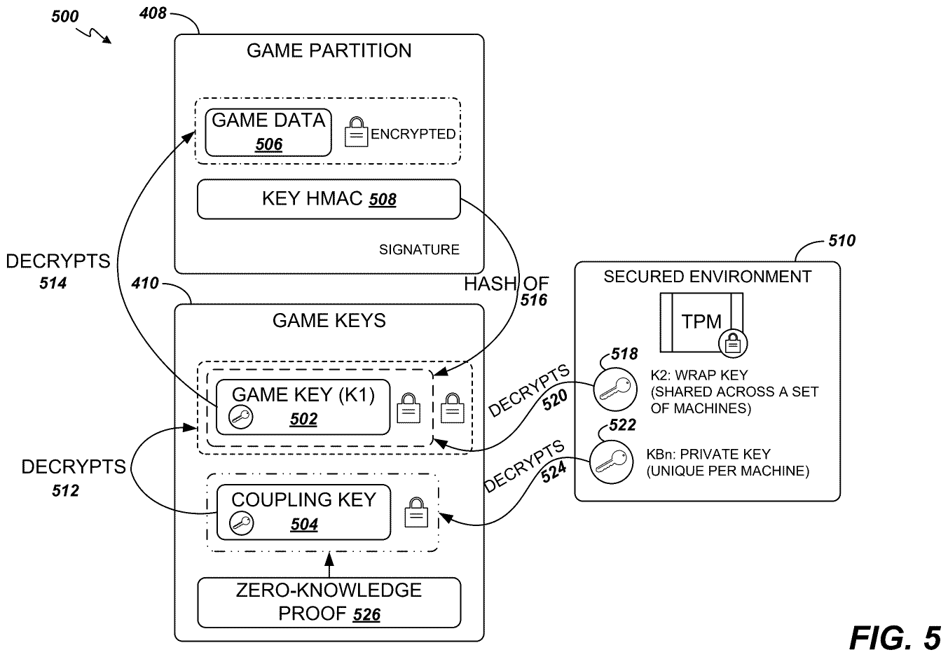

By contrast, game keys 410 (which will be discussed in further detail below and with reference to FIG. 5) may employ a non-deterministic encryption scheme 414, i.e., wherein, even with a given key, the same binary result is not produced each time the same file is encrypted. According to some such embodiments, at least one of the game keys 416 may be unique for a particular machine (or set of machines), thereby allowing for the desired hardware-to-software coupling functionality. Importantly, despite the use of non-deterministic encryption, the media software is independently provable to be correct, i.e., the same as a previously-verified version of the media. For example, in some embodiments, the proof may be performed via one or more so-called “zero knowledge proof” algorithms (i.e., cryptographic methods that allow one party to prove to another party (the “verifier”) that a statement is true, without revealing any information beyond the truth of the statement itself).

Turning now to FIG. 5, a diagram 500 of a technique for performing a hardware-to-software coupling security scheme involving wrapped encryption keys is shown, in accordance with one or more embodiments. The exemplary gaming system illustrated in diagram 500 has three major components, which will be discussed in greater detail: game partition 408; game keys 410 and secured environment 510, which may, e.g., be implemented as a TPM, HSM, TEE, secure enclave, or the like. Game partition 408 may be used to store the game data 506 (e.g., pay tables, game math, etc.) that is created by a game development team and intended for use on a given electronic gaming machine. As described herein, the game data may be encrypted by one or more of the game keys 410. Secured environment 510 may be used to store one or more of the game keys 410 used to perform the hardware-to-software coupling in a secure location.

According to some embodiments, initially, a game key (K1) 502 is generated in a secure environment for the particular game release. Game data 506 may then be encrypted with game key (K1) 502. As may now be appreciated, game key (K1) 502 is capable to decrypt (514) the game data 506, so protecting and encrypting the game key (K1) 502 from unauthorized (or unnecessary) access will be a particular aim of the hardware-to-software coupling schemes disclosed herein. It is important to make sure the game key (K1) 502 never leaves the secured environment 510 or exists on separate physical media. In such cases, the secured environment 510 can decrypt the encrypted key right into itself (i.e., it “unwraps” the key) without it even be accessible to CPU.

Next, a so-called “wrap key” (K2) 518 is generated for a set of cabinets (e.g., a particular generation of cabinets). Wrap key (K2) 518 may then be uploaded onto every cabinet in the set's respective secured environment 510. Game key (K1) 502 K1 may then be encrypted with wrap key (K2) 518, and a hash of that result, e.g., Key Hash-based Message Authentication Code (HMAC) 508, may be stored on game partition 408. Wrap key (K2) 518 may be used to decrypt (520) the encrypted game key (K1) 502.

Next, a so-called “Coupling Key” 504 is generated for each game media instance for each cabinet. Each Coupling Key 504 is unique for each media instance (e.g., memory card), and thus “couples” a game media instance to a particular cabinet. Game key (K1) 502, which has been encrypted with wrap key (K2) (and for which a representation of “K2(K1)” may be used herein), may then be encrypted again with Coupling Key 504, for which a representation of “Coupling_Key(K2(K1)”) may be used. As may now be appreciated, Coupling Key 504 is capable to decrypt (512) the outer layer of the double-wrapped game key, Coupling_Key(K2(K1). Thus, the Coupling Key should be held securely, unless required by a regulator for media verification purposes.

Finally, a private key, KBn 522, is generated on (and is unique to) the gaming machine. The Coupling Key 504 may then be encrypted with KBn 522, for which a representation of “KBn(Coupling_Key(K2(K1)))” may be used herein. As may now be appreciated, KBn 522 is capable to decrypt (524) the outer layer of the thrice-wrapped game key, KBn(Coupling_Key(K2(K1))). As described above, according to some embodiments, a zero-knowledge proof (526) may be used, e.g., by third-party regulators, to verify that the game media is unaltered from a previously-certified status—without such third-party regulators needing to gain access to the actual media source code. Assuming that the KBn key is generated directly on the machine's TPM, no additional key management is needed, i.e., beyond physical access to the TPM itself.

This wrapped encryption key approach to content protection may also be referred to herein as a “multi-layered key” or a “key onion” approach. In other words, the game key (K1) 502 may be wrapped by Wrap key (K2) 518 to hide the game content from third-party regulators, which may then be wrapped by Coupling Key 504 to couple the encrypted key to the media instance, which may then be wrapped by KBn 522, i.e., the private key that is generated uniquely for each gaming machine. In this way, the game key (K1) is protected by multiple, onion-like “layers” of other keys, only accessible to authorized parties. In this way, such third-party regulators would use the Coupling Key 504 to verify the key structure—but not decrypt the actual game data. In some embodiments, as described above, a Key HMAC Signature 508 may be stored in the game partition 408 and used by a third-party regulator to verify the game software.

According to some embodiments, keys may be provisioned prior to assembly of the gaming machine cabinets. For example, during initial motherboard manufacturing, a storage media (e.g., CFast card) may be inserted into a storage media drive of the machine. Once the motherboard boots up, the storage media may then be removed from the motherboard, and the public key and certificate information may automatically be extracted and copied from the writable scratch partition into a writeable location. Once the keys are collected for a number of motherboards, they may be used as described above in the hardware-to-software coupling process.

By storing these game media keys in a secured environment, such as a TPM, it makes retrieval prohibitively expensive, even for the most sophisticated attackers. Further, these techniques make the encryption process reproducible and verifiable—while still protecting the media from unauthorized use. Finally, by storing encryption keys securely in a device specifically designed for making the retrieval of sensitive data prohibitively expensive (e.g., a TPM), the game media cannot be copied or reverse-engineered without a key, which does not work outside of a specific authorized game cabinet(s). As such, there is provided a hardware-to-software coupling scheme for reproducible and verifiable encryption. This allows for the integrity of data (e.g., game media) to be confirmed without access or revelation of the content of the data, which could open the system to security vulnerabilities.

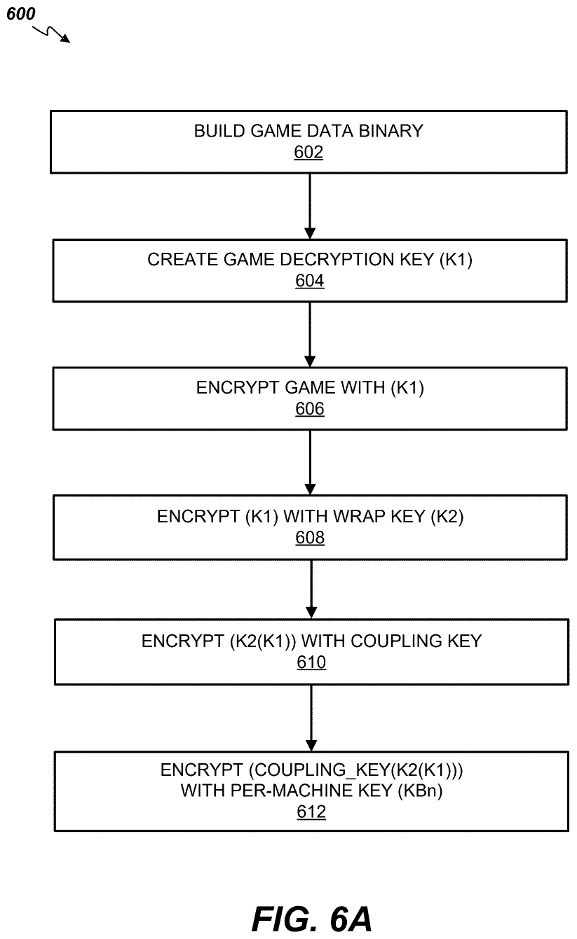

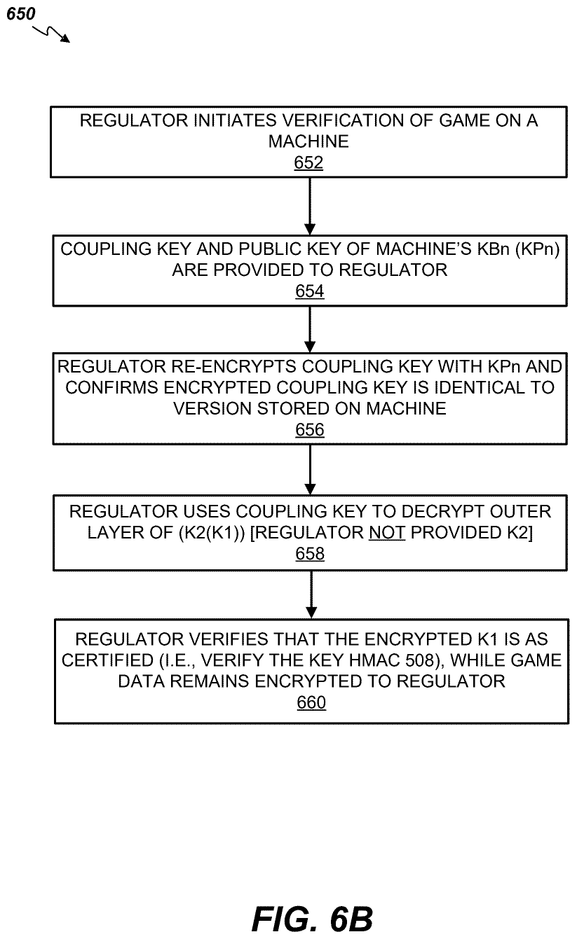

FIG. 6A shows a flowchart 600 summarizing a technique for performing a hardware-to-software coupling security scheme, according to some embodiments, such as those described above. First, at step 602, a developer builds out the game data for a particular game. Next, at step 604, the game decryption key (K1) is created. At step 606, the game data is encrypted with key (K1). At step 608, the game decryption key (K1) is further wrapped (i.e., encrypted) by wrap key (K2). At Step 610, the encrypted game decryption key, K2(K1), is further wrapped (i.e., encrypted) with a cabinet Coupling Key. Finally, at Step 612, the Coupling Key is yet again wrapped (i.e., deterministically) with per-machine key, KBn.

Once a gaming machine boots up, the initiation process may proceed as follows: 1) the machine's bootloader, operating system, and gaming platform, etc. come online; 2) the Coupling Key is decrypted with the per-machine KBn key; 3) The wrapped K2(K1) key is then unwrapped with the Coupling Key; 4) K1 is then unwrapped with K2; and, finally, 5) the game data may be decrypted in the game partition with K1, at which point the game is then available for authorized play by customers.

FIG. 6B shows a flowchart 650 of a technique for performing a software verification operation, e.g., by a third-party regulator, according to some embodiments. When a particular media instance needs verification by a regulator, process 650 may begin at step 652 by the regulator initiating the verification of a particular game media on a particular machine. At step 654, the aforementioned Coupling Key and a public key of the machine's private unique key, KBn, (which will also be referred to here as KPn) are provided to the regulator. At step 656, the regulator re-encrypts the Coupling Key with KPn and confirms that the encrypted coupling key is identical to version stored on machine. According to some embodiments, this encryption algorithm is deterministic, or non-padded RSA, such that the Key HMAC stored in the machine's game partition can be verified as a hashed version of the encrypted game key.

At step 658, the regulator may use the Coupling Key to decrypt only the outer layer of the double-wrapped K1 key, i.e., Coupling Key(K2(K1)). In other words, the regulator is not provided with key K2, so they are unable to decrypt the game key, K1, any further than K2(K1). Finally, at step 660, the regulator may verify that the encrypted game key K1 is as certified (i.e., verify the key HMAC 508 is present on the machine's game partition), while the game data itself remains encrypted to regulator.

### Trusted Platform Modules (TPMs) With Hardware-Implemented Logic

Recent advancements in Field Programmable Gate Array (FPGA) technology have greatly enhanced the security and capacity of electronic devices, particularly with the introduction of bitstream encryption. One of the most significant areas of technological progress lies in the sheer number of logic gates now available in modern FPGAs. With the latest chips incorporating millions of logic elements, they can now fit significantly more functionality and complexity. With the features available in modern FPGAs, it has now become possible to embed business logic into FPGA that would otherwise run on a CPU.

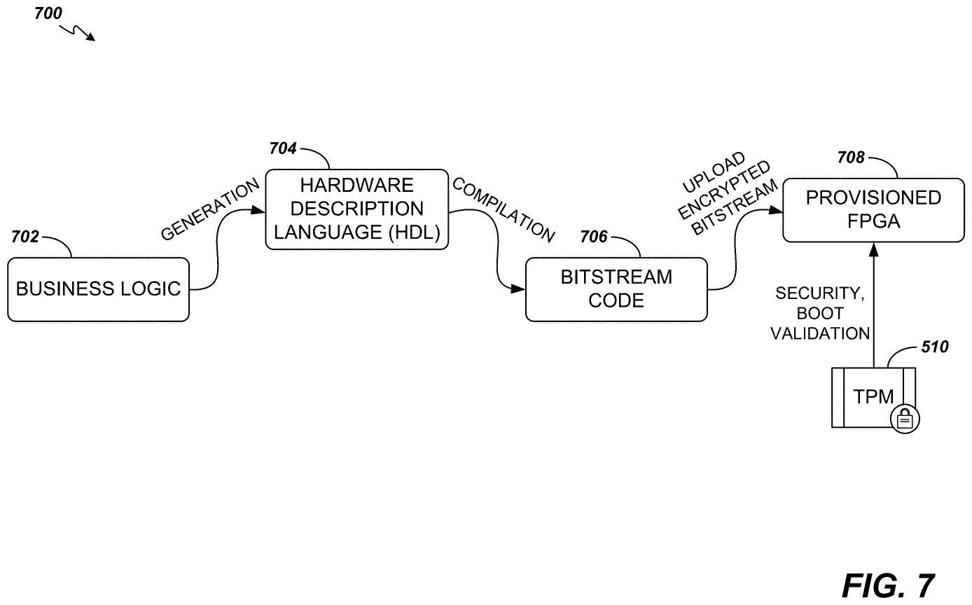

FIG. 7 is a diagram of a technique 700 for utilizing a secured environment, e.g., a Trusted Platform Module (TPM), with hardware-implemented logic, according to some embodiments. The secured environment may be the secured environment 510 shown in FIG. 5, such that features from the above described TPM with hardware-to-software coupling may be combined with the presently described hardware-implemented logic technique. As mentioned above, according to other embodiments, additional copy protections may be provided to game media by moving some (or all) of a game's business logic into hardware. By running some of a game's business logic 702 (e.g., the most valuable or proprietary portions of the business logic) on hardware, such as an FPGA, rather than a CPU, the business logic can be “compiled” into FPGA logic, but reverse engineering is not feasible because of bitstream obfuscation, optimization, encryption and the complexity involved. Returning to FIG. 7, the business logic 702 may be used to generate code in a hardware description language (HDL) 704. The HDL code may then be complied into a bitstream of code 706. The encrypted bitstream code may then be uploaded into a provisioned FPGA 708. If desired, the secured environment 510 (e.g., a TPM) may be used in conjunction with the FPGA to provide additional security and boot validation to the gaming machine.

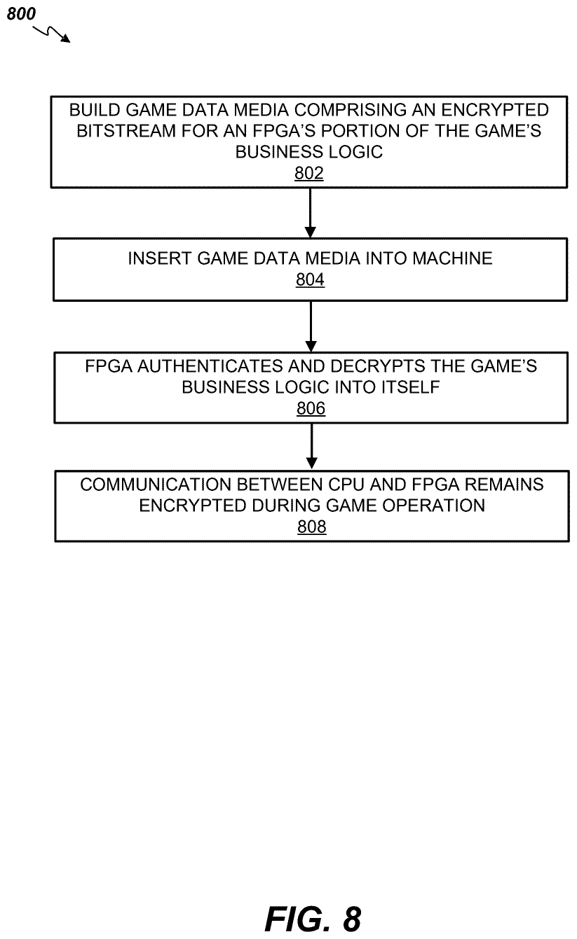

FIG. 8 shows a flowchart 800 of a technique for utilizing a secured environment, e.g., a TPM, with hardware-implemented logic, according to some embodiments. First, at step 802, a developer may build game data media, comprising an encrypted bitstream for an FPGA's portion of the game's business logic. Next, at step 804, the game data media may be inserted into the gaming machine. Next, at step 806, the FPGA authenticates and decrypts the games business logic into itself. Finally, at step 808, game operation commences, during which communications between the CPU and FPGA remain encrypted.

### Trusted Platform Modules (TPMs) With Measured Boot Operations

Measured boot operations are often employed to ensure that a system is in known, uncompromised state. For example, a system may record measurements of various components during a boot process, allowing for later verification that the system has booted with trusted software. Therefore, any cryptographic operations should only be performed if the system is in known state, and measured boot is designed specifically to ensure that a machine is in such a state. For example, the cryptographic operations described above in relation to FIGS. 4-6B may only be performed if the measured boot operations indicate that the machine is in a known state.

More particularly, measured boot is a security mechanism that tracks the integrity of boot process by taking cryptographic measurements of each stage during startup. These measurements may be taken continuously during boot operations by a security device that is part of the platform, e.g., a TPM, thereby ensuring detection of tampering or unauthorized changes to the system's critical components. This process guarantees that the system's boot sequence remains secure and trusted. Secure boot operations block untrusted code from running, while measured boot records each component that loads during startup, regardless of trust level. This allows post-boot verification of system integrity. In measured boot, component measurements are stored in the TPM or other secured environment, enabling detection of unauthorized changes. As may now be appreciated, secure boot prevents threats at system startup; whereas, measured boot provides a log for later analysis to detect potential tampering with the system. As such, there is provided improved protection against reverse engineering and unauthorized access to proprietary data or software components of a system, thereby enhancing the security and integrity of the system.

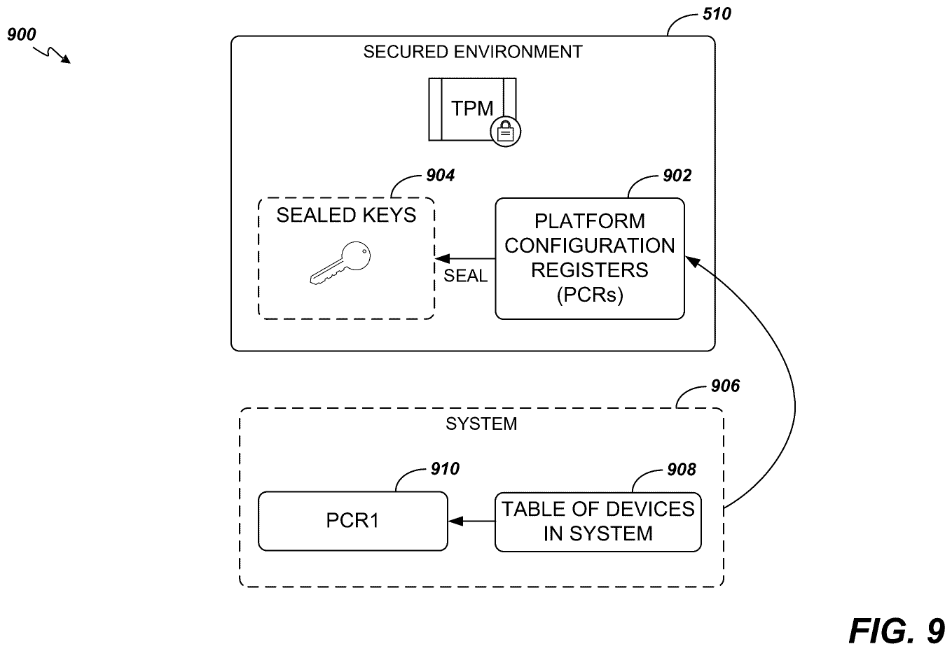

FIG. 9 is a diagram 900 of a technique for utilizing a secured environment, e.g., a TPM, with a measured boot operation, according to some embodiments. The secured environment may be the secured environment 510 shown in FIG. 5, such that the presently-described measured boot operations technique may be combined with features from the above described TPM with hardware-to-software coupling approach and/or hardware-implemented logic approach. Turning first to exemplary system 906, as the system boots, a table of device measurements 908 of key system components are extended into an exemplary platform configuration register (PCR1) 910. Turning next to secured environment 510, it is seen that, in this example, the secured environment (here, implemented in a TPM)'s platform configuration registers (PCRs) 902 can be used to seal one or more sealed keys 904 in the TPM.

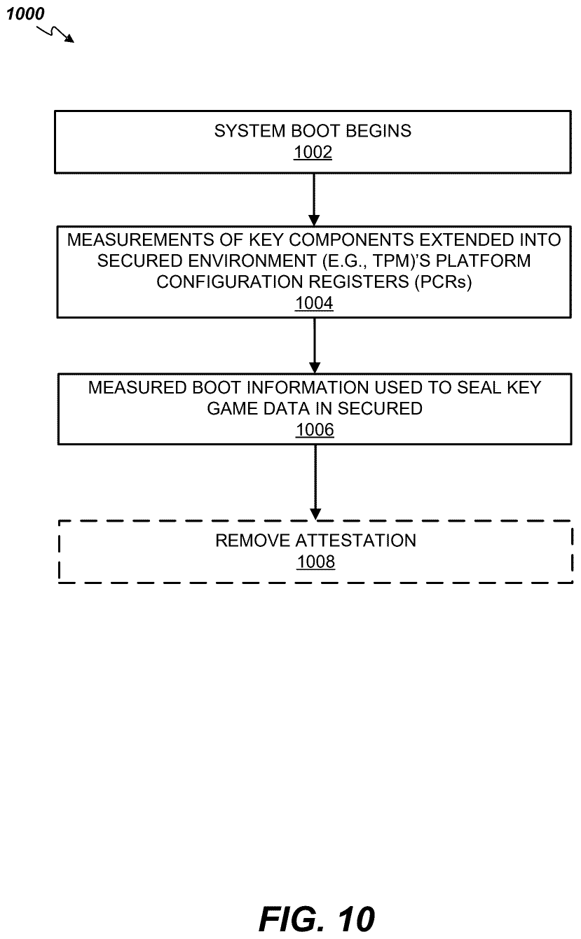

FIG. 10 shows a flowchart 1000 of a technique for utilizing a secured environment, e.g., a TPM, with a measured boot operation, according to some embodiments. First, at step 1002, a system boot operation begins. Next, at step 1004, measurements of one are more key components are extended into the TPM's PCRs. Next, at step 1006, the measured boot information is used to seal key game data in the TPM. Finally, at Step 1008, the process may optionally remove attestation information, i.e., recorded measurements that are used to prove to a remote party (or even locally) that the system has booted in a trusted state.

### Time Lock Puzzles

Often, the most critical parts of an electronic game software to protect are related to the “game math,” i.e., the exact (weighted) probabilities of certain outcomes for every spin. Game math, thus, could be defined as combination of those weights and can be viewed a table with N-rows, wherein more probable outcomes are represented in more of the N-rows of the table. Since it is possible to adjust the total number of possible random outcomes without affecting the respective probabilities, by changing the numbers possible random outcomes to a reasonably high number, it may be possible to conceal the probabilities from a potential reverse engineering attack, i.e., so long as generating a single random outcome takes an appreciable amount of time. For example, a system can be designed using a Time Lock Puzzle encryption scheme, wherein, when a random outcome value must be computed, it takes a predetermined amount of time to do so, but such amount of time delay does not affect the user's experience (for example, 2 to 5 seconds), but wherein it would take an attacker upwards of hundreds of thousands of years to solve the puzzles for all possible outcomes.

Preferably, the puzzle-solving operation should be performed on application-specific integrated circuits (ASICs), and the puzzle complexity should be tuned for them, so that a sophisticated attacker could not use their performance benefits. According to such embodiments, game PAR sheet data may be stored in form of a puzzled-and-then-encrypted chunk of a relatively large capacity hard drive.

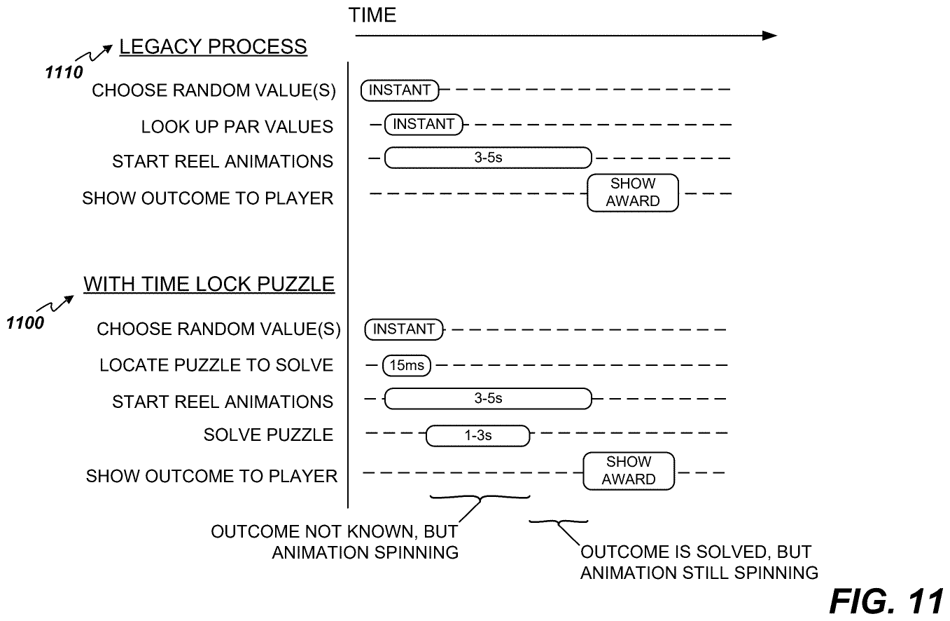

FIG. 11 is a sequence diagram 1100 of a technique for utilizing time lock puzzles in electronic gaming machines, according to some embodiments. This sequence diagram 1100 illustrates how game mechanics can change without affecting user experience. (Note: Diagram 1100 assumes some percentage of the CPU resources are available to do nothing but solve the puzzle, while the reel animation is in progress.)

For example, in a typical legacy process 1110, the choosing of a random value(s) for the given game instance is effectively instantaneous (i.e., the time to generate one random number is on the order of milliseconds), as is the time to look up the corresponding PAR values. Then, a legacy process would 1110 typically start a reel spinning animation on a display of the electronic gaming device, e.g., lasting between 3 to 5 seconds (during which animation the outcome of the game instance is already known to the system), before eventually showing the outcome of the game instance (and any corresponding awards) to the player.

By contrast, in a game process 1100 enhanced with the use of time lock puzzles, the choosing of a random value(s) for the given game instance is also effectively instantaneous; however, once the value is chosen, the corresponding puzzle to be solved is located (which may take on the order of 15 ms). At this point, the game process 1100 may start the reel spinning animation, e.g., again lasting between 3 to 5 seconds (but during which animation the outcome of the game instance is not yet known to the system). During the animation, the CPU may take on the order of 1 to 3 seconds to solve the puzzle and determine what the outcome of the game instance will be. According to some embodiments, the game process 1100 involves generating at least one random number, e.g., by an RNG, and then performing a table-based lookup operation based on the at least one random number to locate an encrypted puzzle stored in a memory of a gaming machine. According to some such embodiments the encrypted puzzle may be part of a set of time-lock puzzles that are used to encrypt a lookup table for determining random game outcomes. As mentioned above, during the solving of the puzzle, the gaming machine may proceed by decrypting the located encrypted puzzle—without needing to decrypt any of the other encrypted puzzles in the set of time-lock puzzles. Then, once the remainer of the reel spinning animation has concluded, the outcome of the game instance and any corresponding awards may be presented to the player. Advantageously, the process of puzzle generation is deterministic, that is, test labs or third-party regulators can independently re-generate puzzles from the same probability content and get exactly the same results. As such, time lock puzzles provide enhanced protection of proprietary data (e.g., game probability data) against malicious attacks (e.g., reverse engineering), thereby making unauthorized decryption infeasible, while maintaining seamless operation of the system.

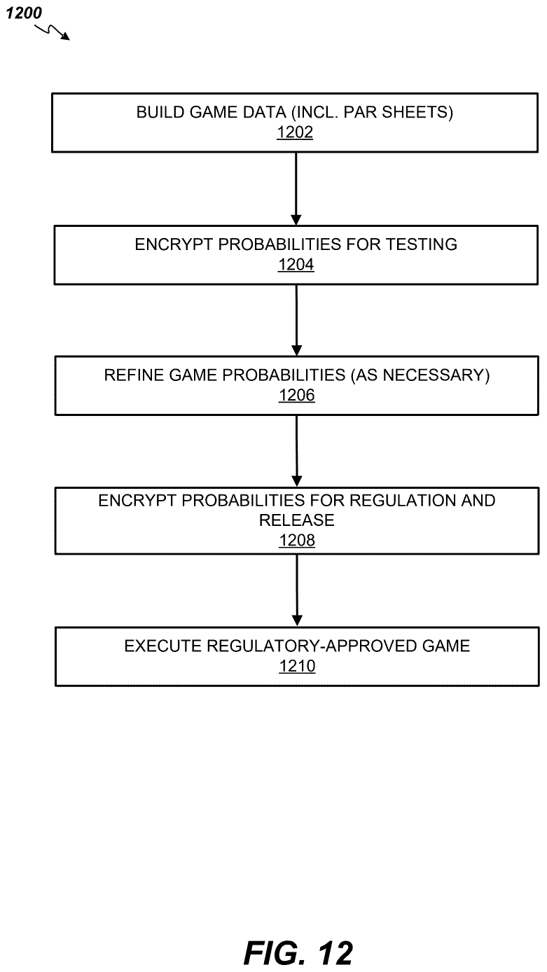

FIG. 12 shows a flowchart 1200 of a technique for utilizing time lock puzzles in electronic gaming machines, according to some embodiments. First, at step 1202 a developer builds a game data file, including game math, such as PAR sheets, or other game probability documentation. Next, at step 1204, at least some of the game probabilities may be encrypted for testing. During the testing phase, at step 1206, the game probabilities may be refined as necessary. When the game is ready for regulatory review, at step 1208, the refined probabilities may be encrypted for regulation and eventual release. Finally, at step 1210, the developer may ship and execute the regulatory-approved version of the game.

### Trusted Platform Modules (TPMs) With Locked Licensing

According to some embodiments, additional sensors may be installed on various game cabinets at a gaming site (e.g., a casino) and used to measure and infer the precise “market” (e.g., location, usable time period, and the like) that the machine is located in. During activation, the machine's secured environment, e.g., a TPM, “locks” the game media's license activation into such market. Then, if or when the sensor parameters later change beyond a permissible threshold amount, the TPM becomes unable to unseal the sealed license key, at which point, reactivation of the game media would be required before the game media could again be executed.

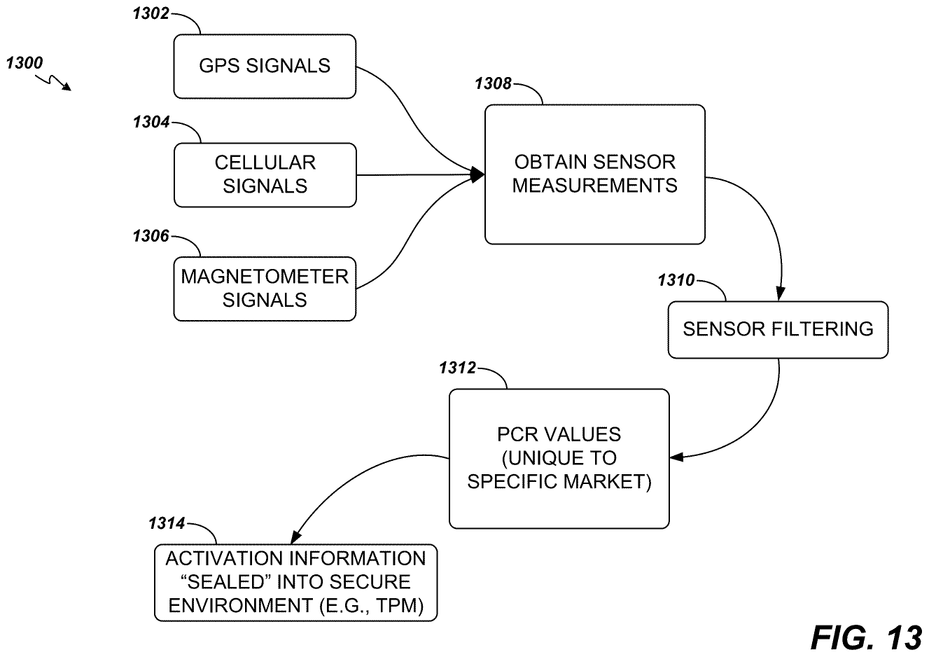

FIG. 13 is a diagram of a technique 1300 for utilizing a secured environment, e.g., a TPM, to lock game licensing activation to a particular market, according to some embodiments. The secured environment may be the secured environment 510 shown in FIG. 5, such that the presently described measured boot operations technique may be combined with features from the above described TPM with hardware-to-software coupling approach, the hardware-implemented logic approach, and/or the measured boot operations approach. As mentioned above, a gaming machine may obtain one or more sensor measurements (e.g., GPS signals 1302, cellular signals 1304, magnetometer 1306, etc.) based on the gaming machine's current environment (1308). If desired, one or more filtering operations (1310) may be applied to the obtained sensor measurements, such that only the portion of the sensor information that is relevant for usage is in the license locking operation may be stored into PCRs of the TPM (1312). Finally, the activation information may be “sealed” into the machine's TPM (1314). Locked licensing cryptographically binds license activation of a machine to environmental sensor data via a TPM, thereby preventing unauthorized relocation or use of the machine outside a dedicated market (e.g., location or zone). This further allows the machine lock to be made in-situ and can be adjusted to a new market if needed without requiring off-site reconfiguration.

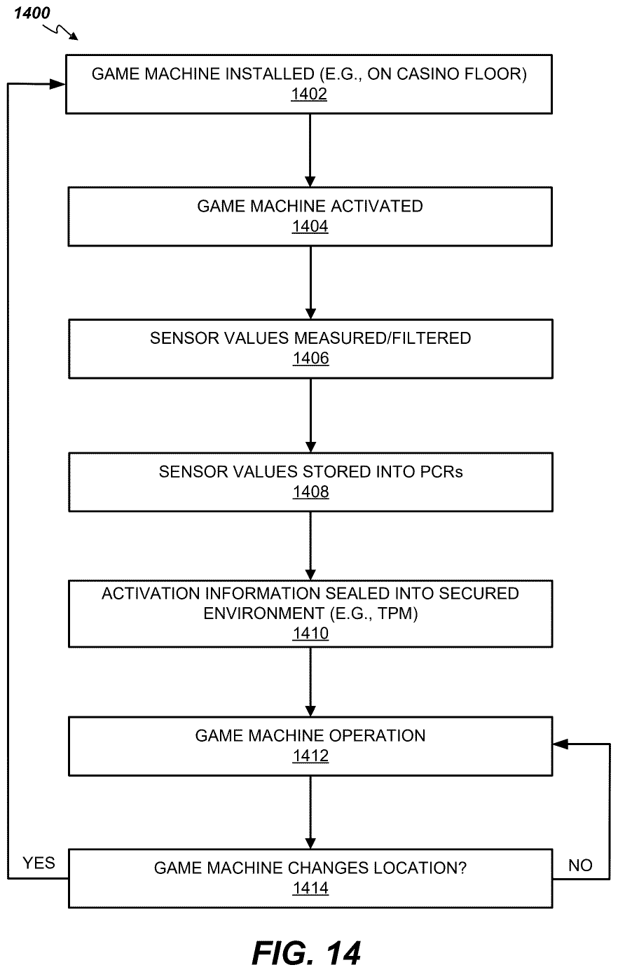

FIG. 14 shows a flowchart 1400 of a technique for utilizing a secured environment, e.g., a TPM, of a gaming machine to lock game licensing activation to a particular market, according to some embodiments. First, at step 1402, a game machine installed (e.g., on casino floor) and is then initially activated at step 1404. Next, at step 1406, internal sensors of the gaming machine measure one or more values, which may be filtered (as necessary) to obtain the information that is relevant for usage is in the license locking operation. Next, at step 1408, the sensor values may be stored into PCRs of the TPM. At step 1410, the activation information (i.e., the PCR values unique to the specific market where the gaming machine is located) are used as the key material to cryptographically seal the licensing information into the machine's TPM. Then, at step 1412, the gaming machine can begin normal operations. After some amount of operation time, at step 1414, if it is determined that the gaming machine has changed locations (i.e., “YES” at step 1414), the flowchart 1400 may return to step 1402, wherein the license activation operation will have to be performed again before the license information can be decrypted and the game can again resume normal operations. Examples of a gaming machine changing locations may be as simple as a machine changing floors or locations within the same facility, or as drastic as being moved to another facility (and/or jurisdiction) altogether. If, instead, at step 1414, if it is determined that the gaming machine has not changed locations (i.e., “NO” at step 1414), the flowchart 1400 may return to step 1412, and continue normal operations, i.e., without requiring any reactivation.

### Inter-Cabinet Communications

According to still other embodiments, a group of gaming machine cabinets may be equipped with proprietary radio modules (e.g., Thread, LoRaWAN/LoRa MESH, Zigbee, or other protocols may be used, as is desired for a given implementation), in order to establish long-range communication between the cabinets as a group. In such a scenario, as long as one of the machines from the group gets any necessary updated license information, e.g., from an Administrator (or other authorized personnel), the whole group of cabinets is able to receive a corresponding license information update. This type of an embodiment reduces the friction faced by operators by requiring minimal additional overhead for necessary license information update operations. However, special care should be taken to make the system's functionality limited only to licensing needs. In some such embodiments, immutable ledgers, e.g., blockchain databases, may also be used to store licensing information.

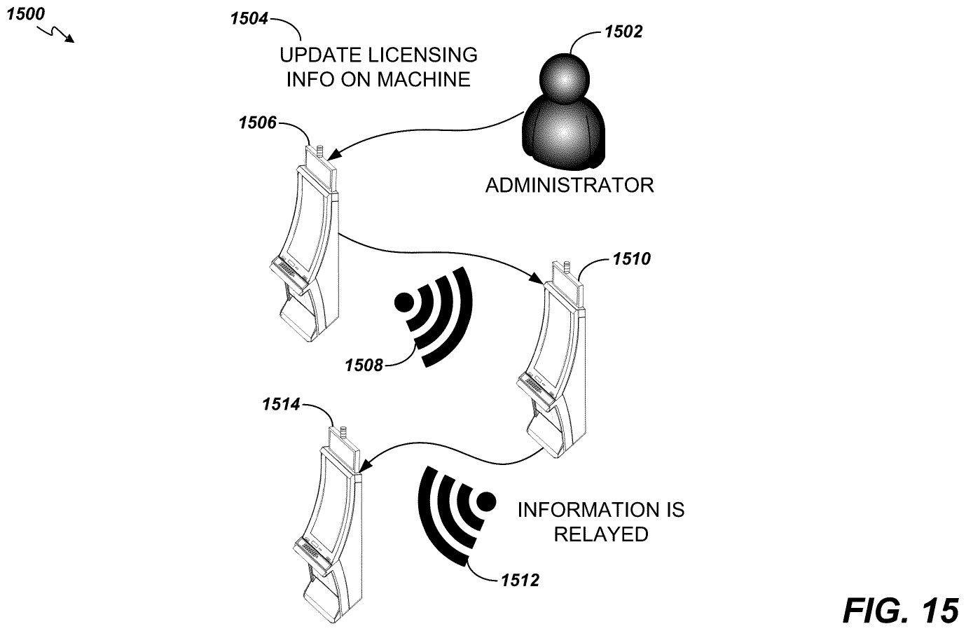

FIG. 15 is a diagram 1500 of a technique for utilizing inter-cabinet communications between electronic gaming machines for licensing-related operations, according to some embodiments. First, at step 1502, an Administrator may seek to update the licensing information (1504) on an electronic gaming machine (1506). In this scenario, gaming machine 1506 is part of a group of electronic gaming machines that also includes gaming machine 1510 and 1514. Using one or more proprietary radio modules, machine 1506 may transmit (1508) the updated licensing information machine 1510, which may, in turn, relay (1512) the information to machine 1514. As mentioned above, this type of an embodiment requires less overhead for operators when they need to update license information on a medium or large-sized group of electronic gaming machines. As such, inter-cabinet communication provides reduced operational overhead and improved scalability of license management across multiple machines—both securely and wirelessly, e.g., using proprietary radio modules.

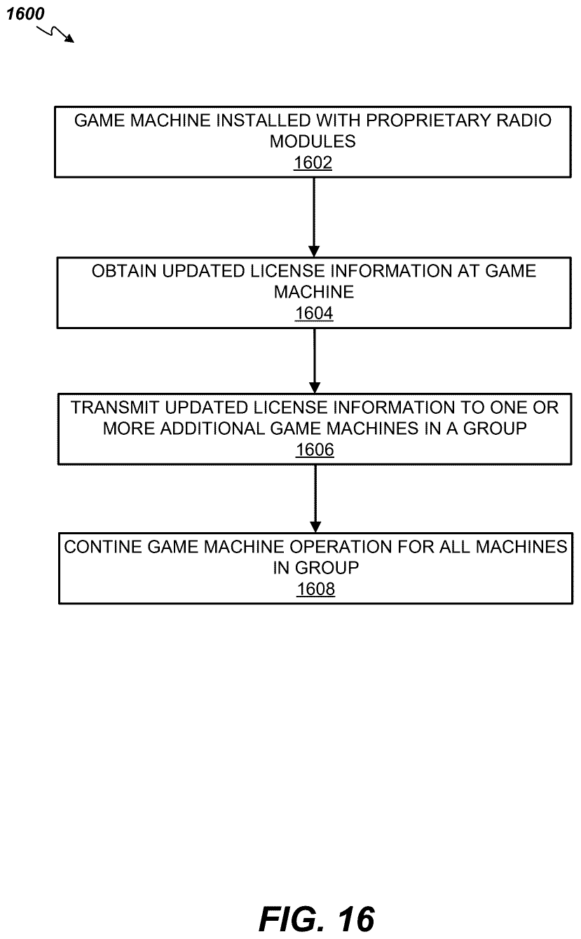

FIG. 16 shows a flowchart 1600 of a technique for utilizing inter-cabinet communications between electronic gaming machines for licensing-related operations, according to some embodiments. First, at step 1602, a gaming machine is installed at a site (e.g., at a casino floor) with proprietary radio modules. Next, at step 1604, at least one machine is updated (e.g., by an Administrator or other authorized personnel) with new license information. Next, at step 1606, the electronic gaming machine may transmit the updated license information to one or more additional game machines in a group. Finaly, at step 1608, game machine operations may continue (with the updated license information) for all gaming machines in the group.

### Delayed Linkage Between EGM and Smart Cards In The Field

According to still other embodiments, techniques are disclosed wherein a game software storage media (e.g., a Compact Fast (CFast) card, or the like) and a smart card (e.g., any type of chip-based or non-chip-based access card or other type of security device) are linked at production time, and subsequently, the smart card and two or more hardware components of an EGM that the smart card is installed into are linked in the field, e.g., once it has been confirmed that a specified usage criteria has been met.

For example, in some embodiments, the game software that is stored in the CFast card installed into an EGM can write an “EGM identifier” (e.g., a backplane ID, as will be described below) and a “carrier board identifier” to the smart card after the EGM has been powered on for at least X hours and/or after Y rounds of play of the game software have been played on the EGM. The usage criteria (e.g., the values of X and Y, in the example above) are customizable for the needs of a given implementation, and may be configured to give an original purchaser of a game more (or less) time to experiment with gameplay, move EGM components, replace faulty EGM components, perform game testing, etc., before permanently linking the EGM's hardware components via the smart card. In still other embodiments, the usage criteria could comprise different types of values, such as a minimum amount of currency that needs to be wagered within the game before the usage criteria is met, a minimum number of unique days that the game has been played on the EGM, etc.

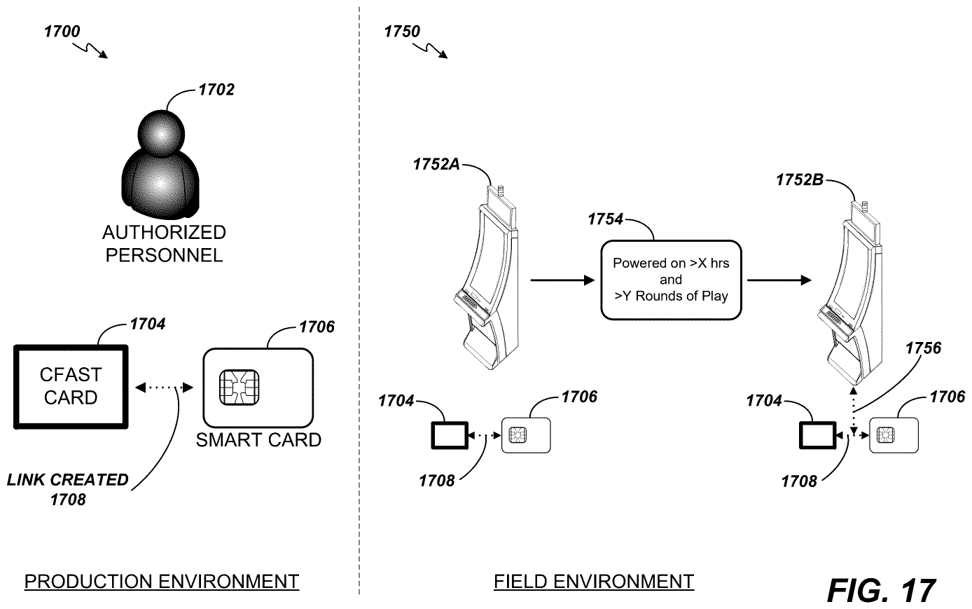

Turing now to FIG. 17, a diagram is shown, illustrating a technique for linking 1708 game software storage media 1704 and a smart card 1706 (e.g., as carried out in a production environment 1700 and/or under the supervision of an authorized personnel 1702), and then subsequently linking 1756 the smart card and the game software storage media with the EGM hardware components (e.g., in a field environment 1750), i.e., when a usage criteria 1754 is determined to be met (e.g., in terms of a certain amount of play and/or elapsed power-on duration).

As illustrated in FIG. 17, for an EGM at a first time (shown at 1752A), the game software storage media 1704 and smart card 1706 may be uniquely linked to each other via the link 1708 created in the production environment, but they are not yet linked to the EGM hardware, e.g. due to the usage criteria not being met yet. Then, after usage criteria 1754 are determined to be met, the same EGM at a second time (shown at 1752B) may be also linked 1756, e.g., via two or more unique IDs associated with EGM hardware components, to the game software storage media 1704 and smart card 1706.

As may now be appreciated, one purpose of waiting until the one or more usage criteria (e.g., as defined in terms of various game parameter thresholds) are met before linking the smart card to the EGM hardware is to allow for original purchasers of a game to be able to perform sufficient field testing of a game and/or perform any troubleshooting that may be needed prior to establishing a permanent EGM link. Oftentimes, troubleshooting a game in the field may involve swapping out failed components with operating components. If the smart card and/or game software were linked with the EGM too early (e.g., immediately upon installation), a technician would be unable to perform additional testing or troubleshooting with the operational components that replaced the malfunctioning components.

According to some embodiments, to link the EGM to the smart card and game program, the game program reads two or more EGM hardware identifiers, e.g., both an EGM ID (e.g., a cabinet ID, backplane ID, or another ID or serial number of some other EGM hardware component that is not easily removable) and a carrier board identifier, and writes the EGM hardware identifier information to the smart card. The EGM identifier (“EGM ID”) could be, e.g., an EGM serial number created at production, or other suitable unique identifier tied to the EGM cabinet. The carrier board identifier could be an FPGA identifier used in the carrier board, or other suitable unique identifier tied to the carrier board of the EGM where the game media and smart card have been installed. Having two (or more) EGM hardware identifiers allows for added flexibility, e.g., when one of the EGM parts fails or an original customer would like to move the game to another authorized EGM cabinet within their facility, etc.

To implement such flexibility, once the EGM identifier and carrier board identifier are written into the smart card, the game program may check whether the EGM identifier and carrier board identifier match the identifiers stored in the smart card. If, e.g., only one of the identifiers matches, the smart card may be configured to allow the non-matching identifier(s) to be written into the smart card to update the smart card. To prevent unauthorized movement, the smart card may be configured to only allow a predefined maximum number of rewrites (e.g., 5 rewrites, 10 rewrites, 100 rewrites, etc.). After the smart card can no longer be updated, a mismatch in any of the EGM identifiers would require the authorized customer to contact the game supplier for a new smart card and game software storage media combo. Thus, delayed linkage between EGM and smart cards helps improve the flexibility and reliability of deployment and maintenance of games. Linking game software and smart cards to a specific machine only after usage criteria are met helps provide secure field testing, while also helping to reduce the possibility of unauthorized use or resale of the machine.

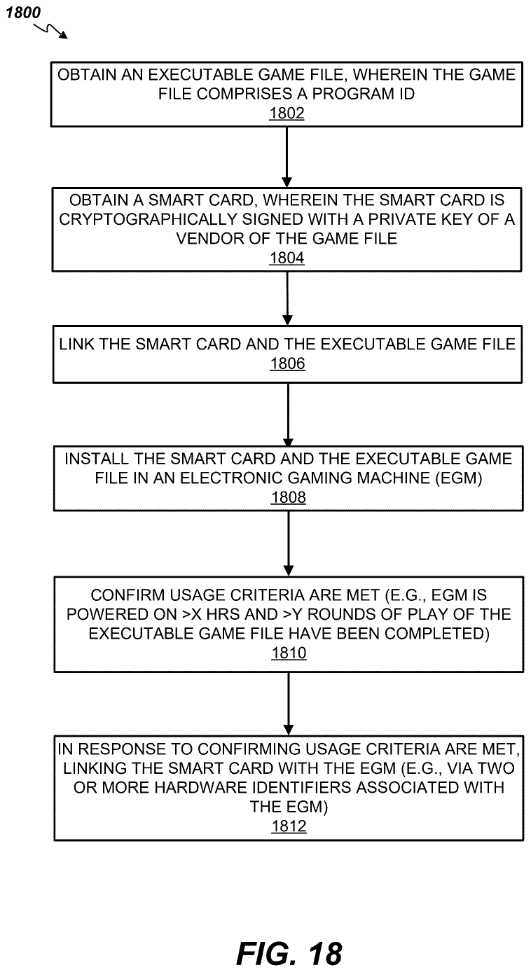

FIG. 18 shows a flowchart 1800 of a technique linking game software storage media and a smart card at production, and then subsequently linking the smart card and EGM hardware components in the field after a certain amount of play and/or time elapses, according to some embodiments. First, at step 1802, an executable game file may be obtained (e.g., at an EGM), wherein the game file comprises at least a unique software ID. Next, at Step 1804, a smart card may be obtained (e.g., at the EGM), wherein the smart card is cryptographically signed with a private key of a vendor of the game file.

At Step 1806, it is recited that the smart card and the executable game file are linked (e.g., via the game file's unique software ID, or other form of game identifier). As described above, according to some embodiments, the smart card and the executable game file may have been previously linked, e.g., at production time of the game file, and in a secure environment by a vendor of the game. In some embodiments, the linkage between the smart card and the executable game file may comprise writing a unique software ID of the executable game file into the smart card in an unalterable fashion.

At Step 1808, the smart card and the executable game file may be installed in the EGM and begin execution. At Step 1810, a processor of EGM may confirm whether any predetermined usage criteria are met. For example, as described above, the usage criteria may comprise confirming that the EGM has been powered on for at least X hours (e.g., 24 hours, 48 hours, 72 hours, etc.), i.e., a “minimum required power-on duration” criterion for the EGM, and/or that at least Y rounds of game play of the executable game file have been completed (e.g., 10 rounds of play, 100 rounds of play, 1,000 rounds of play, etc.), i.e., “a minimum required number of rounds of game play” criterion for the EGM.

At Step 1812, and in response to confirming that all of the usage criteria are met, the smart card and the executable game file may be linked with the EGM (e.g., via two or more hardware identifiers associated with the EGM, as described above). For example, in some embodiments, the two or more hardware identifiers associated with the EGM may comprise a carrier board ID (e.g., a unique hardware ID on a motherboard component, graphic card, or the like, which may be easily moved from one EGM to another EGM) and an EGM ID (e.g., an ID associated with a non-easily removable part of the EGM cabinet, such as a backplane, panel, port, wall board, or the like). As may now be appreciated, once the smart card and EGM-related hardware IDs are linked, if a game software is subsequently loaded up and the IDs do not match, the EGM processor will not allow the game to be played, thus limiting the value of any potentially unauthorized resale activities.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. A computer-implemented method, comprising:
obtaining an executable game file on a game machine;
executing a round of gameplay in the executable game;
generating at least one random number, based on output from a random number generator (RNG);
performing a lookup operation based on the at least one random number to locate an encrypted puzzle stored in a memory of the gaming machine, wherein the encrypted puzzle is part of a set of time-lock puzzles used to encrypt at least one lookup table for determining random game outcomes;
decrypting the located encrypted puzzle stored in the memory of the gaming machine without decrypting other encrypted puzzles in the set of time-lock puzzles;
solving the decrypted puzzle;
determining a result for the round of gameplay based on the solved puzzle; and
displaying the result for the round of gameplay on a display of the game machine.

2. The method of claim 1, wherein the executable game file comprises one or more Probability Accounting Report (PAR) sheets.

3. The method of claim 2, wherein each PAR sheet comprises one or more probability values, and wherein the one or more probability values for each PAR sheet are encrypted.

4. The method of claim 1, wherein one or more animations are initiated on the display of the game machine during the decrypting and solving of the puzzle.

5. The method of claim 4, wherein the result for the round of gameplay is not known when the one or more animations are initiated.

6. The method of claim 1, wherein solving the decrypted puzzle is configured to take longer than a predetermined minimum solve time duration.

7. The method of claim 6, wherein solving the decrypted puzzle is further configured to take less than a duration of one or more animations associated with the round of gameplay.

8. An electronic gaming machine (EGM), comprising:
one or more processors;
a display;
a memory; and
control logic, implemented using the one or more processors and the memory, configured to perform operations, comprising:
obtaining an executable game file on the EGM;
executing a round of gameplay in the executable game;
generating at least one random number, based on output from a random number generator (RNG);
performing a lookup operation based on the at least one random number to locate an encrypted puzzle stored in the memory, wherein the encrypted puzzle is part of a set of time-lock puzzles used to encrypt at least one lookup table for determining random game outcomes;
decrypting the located encrypted puzzle stored in the memory without decrypting other encrypted puzzles in the set of time-lock puzzles;
solving the decrypted puzzle;
determining a result for the round of gameplay based on the solved puzzle; and
displaying the result for the round of gameplay on the display of the EGM.

9. The electronic gaming machine of claim 8, wherein the executable game file comprises one or more Probability Accounting Report (PAR) sheets.

10. The electronic gaming machine of claim 9, wherein each PAR sheet comprises one or more probability values, and wherein the one or more probability values for each PAR sheet are encrypted.

11. The electronic gaming machine of claim 8, wherein one or more animations are initiated on the display of the electronic gaming machine during the decrypting and solving of the puzzle.

12. The electronic gaming machine of claim 11, wherein the result for the round of gameplay is not known when the one or more animations are initiated.

13. The electronic gaming machine of claim 8, wherein solving the decrypted puzzle is configured to take longer than a predetermined minimum solve time duration.

14. The electronic gaming machine of claim 13, wherein solving the decrypted puzzle is further configured to take less than a duration of one or more animations associated with the round of gameplay.

15. One or more non-transitory computer-readable media storing computer-executable instructions, which, when executed by one or more processors of an electronic gaming machine (EGM), cause the EGM to perform the following operations:
obtaining an executable game file on the EGM;
executing a round of gameplay in the executable game;
generating at least one random number, based on output from a random number generator (RNG);
performing a lookup operation based on the at least one random number to locate an encrypted puzzle stored in a memory of the EGM, wherein the encrypted puzzle is part of a set of time-lock puzzles used to encrypt at least one lookup table for determining random game outcomes;
decrypting the located encrypted puzzle stored in the memory of the EGM without decrypting other encrypted puzzles in the set of time-lock puzzles;
solving the decrypted puzzle;
determining a result for the round of gameplay based on the solved puzzle; and
displaying the result for the round of gameplay on a display of the EGM.

16. The one or more non-transitory computer-readable media of claim 15, wherein the executable game file comprises one or more Probability Accounting Report (PAR) sheets, and wherein the one or more probability values for each PAR sheet are encrypted.

17. The one or more non-transitory computer-readable media of claim 15, wherein one or more animations are initiated on the display of the electronic gaming machine during the decrypting and solving of the puzzle.

18. The one or more non-transitory computer-readable media of claim 17, wherein the result for the round of gameplay is not known when the one or more animations are initiated.

19. The one or more non-transitory computer-readable media of claim 15, wherein solving the decrypted puzzle is configured to take longer than a predetermined minimum solve time duration.

20. The one or more non-transitory computer-readable media of claim 19, wherein solving the decrypted puzzle is further configured to take less than a duration of one or more animations associated with the round of gameplay.
